(19) United States
(12) Patent Application Publication
(10) Pub. No.: US 2005/0178729 A1
(43) Pub. Date: Aug. 18, 2005

(54) Maintenance cleaning for membranes

(76) Inventors: Hamid R. Rabie, Mississauga (CA); Hidayat Husain, Brampton (CA); Henry Behmann, Puslinch (CA)

Correspondence Address: BERESKIN AND PARR, 40 KING STREET WEST, BOX 401, TORONTO, ON, M5H 3Y2, CA

(21) Appl. No.: 11/106,681

(22) Filed: Apr. 15, 2005

Related U.S. Application Data
(63) Continuation-in-part of application No. 10/461,687, filed on Jun. 16, 2003.
Application No. 10/461,687 is a continuation of application No. 09/425,234, filed on Oct. 25, 1999.
(63) Continuation-in-part of application No. 09/916,247, filed on Jul. 30, 2001.
Application No. 09/916,247 is a continuation-in-part of application No. 09/425,234, filed on Oct. 25, 1999.
Application No. 09/916,247 is a continuation-in-part of application No. 09/425,235, filed on Oct. 25, 1999, now Pat. No. 6,547,968.
Application No. 09/916,247 is a continuation-in-part of application No. 09/425,236, filed on Oct. 25, 1999, now Pat. No. 6,303,035.
(60) Provisional application No. 60/146,154, filed on Jul. 30, 1999.
(60) Provisional application No. 60/146,154, filed on Jul. 30, 1999.

(51) Int. Cl. B01D 65/02

(52) U.S. Cl. 210/636; 210/639; 210/650; 210/321.69

(57) ABSTRACT

A method of cleaning ultrafiltration or microfiltration membranes reduces the rate of decline in the permeability of the membranes so that intensive recovery cleaning is required less frequently. In one aspect, cleaning events using a chemical cleaner are started before the membranes foul significantly and are repeated between 1 and 7 times per week. The product of the concentration of the chemical cleaner expressed as an equivalent concentration of NaOCl and the duration of all cleaning events is between 2,000 minutes·mg/l and 30,000 minutes·mg/l per week. When performed in situ, each cleaning event comprises (a) stopping permeation and any agitation of the membranes, (b) backwashing the membranes with a chemical cleaner in repeated pulses and (c) resuming agitation, if any, and permeation. The pulses last for between 10 seconds and 100 seconds and there is a time between pulses between 50 seconds and 6 minutes. Each cleaning event typically involves between 5 and 20 pulses. In another aspect, cleaning events using a pulsed backwash of heated water are similarly started before the membranes foul significantly and are repeated between twice a day and once every two days.

This application is (1) a continuation-in-part of U.S. patent application Ser. No. 10/461,687 filed Jun. 16, 2003 which is a continuation of U.S. patent application Ser. No. 09/425,234, filed Oct. 25, 1999 which is an application claiming the benefit under 35 USC 119(e) of provisional application No. 60/146,154, filed Jul. 30, 1999; (2) a continuation-in-part of U.S. patent application Ser. No. 09/916,247 filed Jul. 30, 2001 which is (i) a continuation-in-part of U.S. patent application Ser. No. 09/425,234, filed Oct. 25, 1999, (ii) a continuation-in-part of U.S. patent application Ser. No. 09/425,235, filed Oct. 25, 1999; and, (iii) continuation-in-part of U.S. patent application Ser. No. 09/425,236, filed Oct. 25, 1999; and, this application is (3) a continuation-in-part of U.S. patent application No. U.S. patent application Ser. No. 09/425,234, filed Oct. 25, 1999 which is an application claiming the benefit under 35 USC 119(e) of provisional application No. 60/146,154, filed Jul. 30, 1999. All applications listed in this paragraph are incorporated herein, in their entirety, by this reference to them.

### FIELD OF THE INVENTION

This invention relates to cleaning ultrafiltration or microfiltration membranes with a cleaning chemical.

### BACKGROUND OF THE INVENTION

Membranes are used for separating a permeate lean in solids from a feed water rich in solids. Typically, one or more membranes have a retentate side in fluid communication with the feed water and a permeate side at which permeate is collected. Filtered feed water permeates through the walls of the membranes under the influence of a transmembrane pressure differential between the retentate side of the membranes and the permeate side of the membranes. Solids in the feed water are rejected by the membranes and remain on the retentate side of the membranes. The solids may be present in the feed water in solution, in suspension or as precipitates and may further include a variety of substances, some not actually solid, including colloids, microorganisms, exopolymeric substances excreted by microorganisms, suspended solids, and poorly dissolved organic or inorganic compounds such as salts, emulsions, proteins, humic acids, and others.

Over time, the solids foul the membranes which decreases their permeability. As the permeability of membranes decreases, the yield of the process similarly decreases or a higher transmembrane pressure is required to sustain the same yield. To prevent the decreased yield of the process or the increased transmembrane pressure from becoming unacceptable, the membranes must be cleaned.

Any solid can contribute to fouling and reduced membrane permeability, and the fouling may occur in different ways. Fouling can also occur at the membrane surface or inside of the pores of the membrane. To counter the different types of fouling, many different types of cleaning regimens have been proposed and two or more types of cleaning may be used. Such cleaning usually includes both periodic regular cleaning and intensive recovery cleaning.

For periodic regular cleaning, permeation through the membranes is typically stopped momentarily. Air or water are flowed through the membranes under pressure to backwash the membranes. The force of the backwash physically pushes solids off of the membranes. Typically, the membranes are simultaneously agitated, for example by aerating the feed water around the membranes with large, scouring bubbles to assist in shearing solids from the surface of the membranes. Such back washing and agitation is partially effective in removing solids from the surface of the membranes, but is not very effective for removing solids deposited inside the membrane pores and is almost ineffective for removing any type of solid chemically or biologically attached to the membranes.

Accordingly, fouling continues despite regular back washing and agitation and the permeability of the membranes decreases over time. After a short time, typically in the range of a couple of weeks, the permeability of the membranes reaches an unacceptable value and a different type of cleaning, which may be referred to as intensive recovery cleaning, is preformed.

Although necessary, intensive recovery cleaning may disrupt permeation for an extended period of time and is harsh on the membranes. In a first group of methods, the tank is drained and the membranes are back washed with a solution of chemical cleaners while the outer surfaces of the membranes are physically scrubbed. In a second group of methods, the membranes are soaked in one or more cleaning solutions either in the process tank (after it has been drained and filled with chemical cleaners) or in a special cleaning tank. After such intensive recovery cleaning, the permeability of the membranes is partially restored, but the remaining useful life of the membranes will have been reduced.

A third group of methods of intensive recovery cleaning is described in U.S. Pat. No. 5,403,479 and Japanese Patent Application No. 2-248,836. In these methods, intensive recovery cleaning is performed without draining the tank or removing the membranes from the tank. Permeation is stopped and the membranes are cleaned by flowing a chemical cleaner in a reverse direction through the membranes while the membranes are simultaneously agitated. After the cleaning step, the permeability of the membranes is substantially restored.

Such a process avoids removing the membranes or tank water from the tank but the amount of chemical cleaner is large. For waste water applications, the amount of chemical used in each cleaning event may not destroy the biological processes occurring in the waste water, but it still shocks the microorganisms and disrupts the digestion of mixed liquor. Significant spikes of pollutants are observed after each cleaning by such methods. For potable water applications, the amount of chemical cleaner remaining in the tank after such cleaning events makes such methods unusable. With chemical cleaners based on chlorine, for example, such methods produce unacceptable levels of residual chlorine and trihalomethanes in the permeate.

### SUMMARY OF THE INVENTION

An object of the present invention is to provide a method of cleaning filtering membranes with a backwashed liquid cleaner which reduces the rate of decline in the permeability of the membranes so that intensive recovery cleaning is required less frequently.

In one aspect, the invention provides a method for cleaning membranes by backwashing with a chemical cleaner. Such cleaning events are started before the membranes foul significantly and are repeated between 1 and 7 times per week. The product of the concentration of the chemical cleaner expressed as an equivalent concentration of NaOCl and the duration of all cleaning events is between 2,000 minutes·mg/l and 30,000 minutes·mg/l per week. When performed in situ, each cleaning event comprises (a) stopping permeation and any agitation of the membranes, (b) backwashing the membranes with a chemical cleaner in repeated pulses and (c) resuming agitation, if any, and permeation. The pulses last for between 10 seconds and 100 seconds, there is a time between pulses between 50 seconds and 6 minutes. Each cleaning event typically involves between 5 and 20 pulses.

In another aspect, the invention provides a method for cleaning membranes by backwashing with water heated to more than 25 degrees Celsius. Such cleaning events are started before the membranes foul significantly and are repeated between twice a day and once every two days. When performed in situ, each cleaning event comprises (a) stopping permeation and any agitation of the membranes, (b) backwashing the membranes with the heated water in repeated pulses and (c) resuming permeation and any agitation. The pulses last for between 10 seconds and 100 seconds, there is a time between pulses between 50 seconds and 3 minutes. The duration of each cleaning event is between 30 minutes and 90 minutes.

### BRIEF DESCRIPTION OF THE DRAWINGS

Preferred embodiments of the invention will now be described with reference to the following figure or figures.

FIG. 1 is a schematic diagram of an embodiment of the invention.

FIG. 2 is a chart of results of tests of an embodiment of the present invention used for creating potable water.

FIG. 3 is a chart of results of tests of another embodiment of the present invention used for treating waste water.

### DETAILED DESCRIPTION OF THE INVENTION

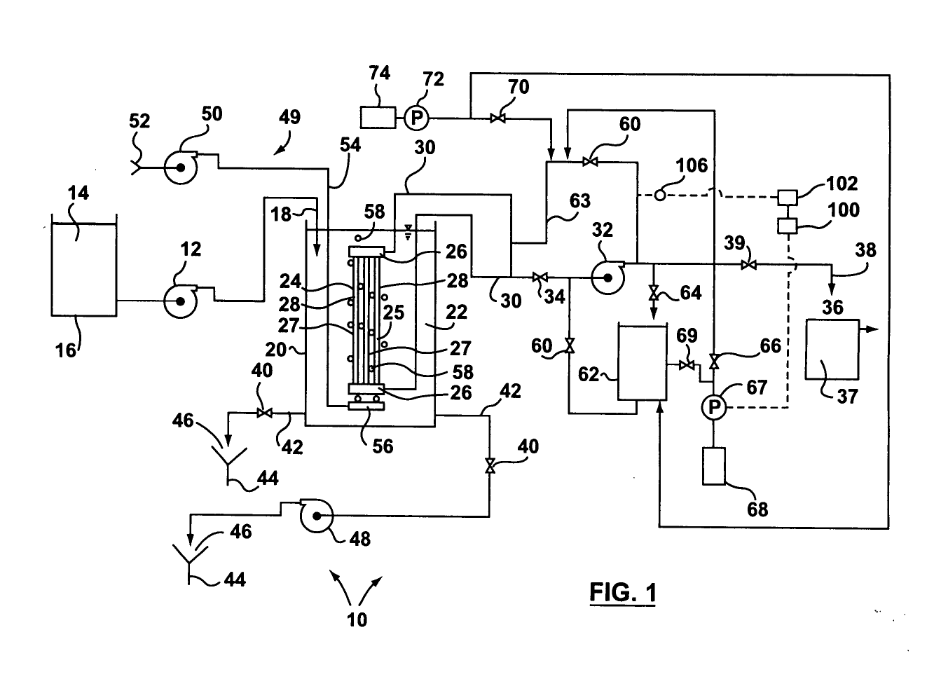

Referring now to FIG. 1, a reactor 10 is shown for treating a liquid feed having solids to produce a filtered permeate substantially free of solids and a consolidated retentate rich in solids. Such a reactor 10 has many applications but will be described below as used for creating potable water from a natural supply of water such as a lake, well or reservoir or for separating clean water from mixed liquor in a waste water treatment plant.

The reactor 10 includes a feed pump 12 which pumps feed water 14 to be treated from a water supply 16 through an inlet 18 to a tank 20 where it becomes tank water 22. If the process is being used for waste water treatment, biological activity in the tank water 22 substantially alters the character and concentration of pollutants in the tank water 22 and the tank water 22 would typically be referred to as mixed liquor. In this description, however, tank water 22 refers to both tank water 22 intended to be filtered for drinking and mixed liquor. During permeation, the tank water 22 is maintained at a level which covers one or more membranes 24. Each membrane 24 has a permeate side 25 which does not contact tank water 22 and a retentate side 27 which does contact the tank water 22.

Membranes 24 made of hollow fibres are preferred although the membranes 24 may be of various other types such as tubular, ceramic, or flat sheet membranes. Typically, headers 26 connect a plurality of hollow fibre or tubular membranes 24 together, the headers 26 sealing the ends of the membranes and connecting the permeate sides 25 of the membranes 24 to appropriate piping. Similarly, flat sheet membranes are typically attached to headers or casings that create an enclosed surface on one side of a membrane or membranes and allow appropriate piping to be connected to the interior of the enclosed surface. A header or casing holding one or more membranes may be referred to as a module. A plurality of modules may also be joined together and may be referred to as a cassette. In this description, however, the words “membrane” and “membranes” both refer to one or more membranes whether or not they are connected in one or more modules or cassettes.

Referring still to FIG. 1, for hollow fibre membranes 24, the retentate side 27 of the membranes 24 is preferably the outside of the membranes and the permeate side 25 of the membranes 24 is preferably their lumens. The permeate sides 25 of the membranes 24 are held in fluid communication with headers 26 and together form a membrane module 28 which is connected to a permeate collector 30 and a permeate pump 32 through a permeate valve 34. When permeate pump 32 is operated and permeate valve 34 and an outlet valve 39 opened, a negative pressure is created in the permeate side 25 of the membranes 24 relative to the tank water 22 surrounding the membranes 24. The resulting transmembrane pressure draws tank water 22 through membranes 24 while the membranes 24 reject pollutants which remain in the tank water 22. Thus, filtered permeate 36 is produced for use at a permeate outlet 38. The transmembrane pressure could alternately be created by pressurizing the tank water 22.

The filtered permeate 36 may require post treatment before being used as drinking water or discharged at the end of a wastewater treatment process, but should have acceptable levels of solids. Preferably, the membranes 24 have an average pore size between 0.003 microns and 10 microns and more preferably between 0.02 microns and 1 micron. Suitable membranes include those sold under the ZEEWEED trade mark and produced by Zenon Environmental Inc. The total size and number of membranes 24 required varies for different applications depending on factors such as the amount of filtered permeate 36 required and the condition of the feed water 14. Similarly, the preferred transmembrane pressure to be applied to the membranes 24 varies for different membranes and the desired yield but typically ranges from 1 kPa to 100 kPa and preferably is less than 67 kPa for ZEEWEED hollow fibre membranes 24.

Tank water 22 which does not flow out of the tank 20 through the permeate outlet 38 flows out of the tank 20 through a drain valve 40 in a retentate outlet 42 to a drain 44 as retentate 46. The retentate 46 is rich in the solids rejected by the membranes 24. When producing potable water, the retentate 46 is typically sent back to the source that the feed water 14 was originally drawn from. In waste water treatment applications, the retentate 46 is a waste sludge which is further processed or disposed of. In drinking water applications, the retentate 46 may be withdrawn from the tank 20 either continuously or periodically. In wastewater applications, the reactor 10 is usually operated continuously. In periodic operation, filtering typically occurs in a batch mode and the tank is emptied frequently. In continuous operation, although there may be short periodic interruptions, feed water 14 flows into the tank 20 and permeate 36 is withdrawn from the tank over extended periods of time and retentate 46 is withdrawn as needed to preserve the required level of tank water 22 in the tank 20. In some drinking water applications, the process operates continuously but for periodic, ie. once a day, tank drainings for maintenance procedures.

During permeation, solids accumulate on the surface of the membranes 24 and in their pores, fouling the membranes 24. Various techniques may prevent some of this fouling. Firstly, the membranes 24 may be agitated, possibly by mechanically agitating the tank water 22 near the membranes 24 but preferably by aerating the tank water 22 near the membranes 24. For this, an aeration system 49 has an air supply pump 50 which blows ambient air from an air intake 52 through air distribution pipes 54 to an aerator 56 which disperses air bubbles 58 into the tank water 22 near the membranes 24. The air bubbles 58 discourage solids from depositing on the membranes 24. Secondly, periodic backwashing may be used. For this, the membranes 24 are backwashed by closing permeate valve 34 and outlet valve 39 and opening backwash valves 60. A pressure tank valve 64 is opened and permeate pump 32 pushes filtered permeate 36 from a pressure tank 62 through a backwash pipe 63 to the headers 26 and through the walls of the membranes 24 in a reversed direction thus pushing away some of the solids attached to the membranes 24. At the end of the backwash, backwash valves 60 are closed and permeate valve 34 re-opened. Permeate pump 32 flows permeate 36 into pressure tank 62 until pressure tank 62 is refilled. Pressure tank valve 64 is then closed and outlet valve 39 opened. Such backwashing may occur approximately every 15 minutes to 90 minutes for a period of 15 seconds to one minute and, although permeation is temporarily disrupted, a continuous process is still considered continuous. Permeate 36 may be stored in a permeate tank 37 to even out minor disruptions in the flow of permeate 36.

With backwashing and the use of air bubbles 58 to clean the membranes 24, permeation typically continues for 1 or 2 weeks before the permeability of the membranes 24 drops to the point where an intensive recovery cleaning event would normally be required.

Embodiments of the present invention, to be described below, are directed at reducing the rate of loss of permeability of the membranes 24 so that the time between intensive recovery cleanings can be lengthened. This strategy is referred to generally as maintenance cleaning. In addition to regular periodic backwashing, cleaning events are performed generally periodically at a frequency preferably ranging from once a day to once a week and more preferably between 2 and 4 times per week. The cleaning events are started before there is significant fouling of fresh membranes 24, preferably while permeability is still above 70% of the permeability of the membranes 24 when fresh, and more preferably within a week of when permeation is started with fresh membranes, fresh meaning new membranes 24 or membranes 24 that have just been through intensive recovery cleaning.

In a first embodiment, each cleaning event involves flowing chemical cleaner through the walls of the membranes 24 while permeation is temporarily stopped in a direction opposite to the direction in which permeate 36 flows through the membranes 24 during permeation. The chemical cleaner used may be any chemical appropriate for the application and not overly harmful to the membranes 24. Typical chemicals include oxidants such as sodium hypochlorite, acids such as citric acid and bases such as sodium hydroxide. The chemical cleaner may be used in a non-liquid form such as by flowing chemical in a gaseous state to the headers 26 or introducing it as a solid into the backwash line 63. Liquid chemical cleaners are preferred, however, because they are easier to handle and inject in the proper amounts.

To flow chemical cleaner through the walls of the membranes 24 while permeation is temporarily stopped, permeate valve 34, outlet valve 39 and backwash valves 60 are all closed and permeate pump 32 turned off. Chemical valve 66 is opened and chemical pump 67 turned on pushing chemical cleaner from chemical tank 68 into backwash line 63 to the headers 26 and through the walls of the membranes 24. Alternately, permeate valve 34 and outlet valve 39 may be closed and backwash valves 60 opened. Permeate pump 32 then pushes filtered permeate 36 from pressure tank 62 through backwash line 63 to the headers 26 and through the walls of the membranes 24. Chemical valve 66 is opened and chemical pump 67 turned on mixing chemical cleaner from chemical tank 68 with permeate 36 flowing through backwash line 63. Further alternately, permeate pump 32 is stopped and chemical valve 66, permeate valve 34 and outlet valve 39 are closed while backwash valves 60 are opened. A cross flow valve 69 is also opened connecting the chemical tank 68 to the pressure tank 62. Chemical pump 67 delivers chemical cleaner to pressure tank 62. Permeate pump 32 is then operated to deliver the chemical cleaner to the membranes 24. Chemical cleaners could also be introduced directly to the headers 26 or the permeate collector 30 which may reduce the total volume used or allow alternate delivery mechanisms.

With some of the methods of flowing chemical cleaner through the walls of the membranes 24 described above, the chemical cleaner may be diluted before reaching the membranes 24. Accordingly, in the subject method the concentration of the chemical cleaner is measured as the chemical cleaner meets the permeate side 25 of the membranes 24 unless stated otherwise. This concentration will be referred to as “C”.

As the chemical cleaner flows towards and through the walls of the membranes 24, it displaces tank water 22 in the lumens of the membranes 24 and in an area adjacent to the membranes. The chemical cleaner surrounds the membranes 24 but is not encouraged to mix with the tank water 22. In particular, sources of agitation such as the aeration system 49 are preferably turned off if they have a significant effect on the tank water 22 adjacent the membranes 24. Without such mixing, some chemical cleaner leaves the area adjacent the membranes 24 but only slowly. In the area adjacent the membranes 24, the chemical cleaner reacts with the solids on or in the membranes 24 killing some microorganisms attached to the membranes 24 and dissolving some of the solids. Outside of this area, the concentration of chemical cleaner in the tank water 22 drops.

The effectiveness of the chemical cleaner is dependant on the concentration of the chemical cleaner and the time that the chemical cleaner remains effective in the area adjacent the membranes 24. For process calculations, the concentration of the chemical cleaner in the area adjacent the membranes 24 is assumed to be the same as the initial concentration of the chemical cleaners 24, C. The time during which the chemical cleaner remains effective in the area adjacent the membranes 24 will be called “T”. Permeation and agitation are stopped, preferably for about five minutes, before the chemical cleaner starts to flow through the membranes 24. After the flow of chemical cleaner stops, agitation is resumed for about ten minutes to dilute the chemical cleaner in the area adjacent the membranes 24 before permeation resumes.

In the above case, T is assumed for calculations to be the time between when chemical cleaner starts to flow through the membranes 24 and when agitation is resumed, provided that agitation resumes within about five minutes after the flow of chemical cleaner stops. If necessary, the permeate side 25 of the membranes 24 and piping containing chemical may also be flushed with a backpulse of filtered permeate 36 before resuming permeation, in which case the start of this backpulse would be the end of the cleaning event if it had not already ended. Alternatively, permeation may resumed before agitation. This method is advantageous in that chemical cleaner in the area adjacent the membranes 24 is not dispersed into the tank 20, but the permeate 36 collected before resuming agitation is preferably wasted or recycled to the tank water 22 to reduce the amount of chemical cleaner entering the permeate tank 37. In this case, T is assumed for calculations to be the time between when chemical cleaner starts to flow through the membranes 24 and when the first of agitation or permeation are resumed, provided that agitation or permeation resumes within about five minutes after the flow of chemical cleaner stops.

The effectiveness of a cleaning event is approximated by multiplying the C and T parameters to create a third parameter “CT”. Since the cleaning events may be repeated with varying frequency for different applications or concentrations of solids in the feed water 14, a parameter called the weekly CT is used as a basis for some calculations. The weekly CT is the sum of the CT parameters for the cleaning events performed during a week. If cleaning events are performed less frequently than once a week, a monthly CT parameter can be used instead with appropriate modifications to the calculations which depend on the weekly CT parameter.

The desired weekly CT is preferably chosen to maintain acceptable permeability of the membranes 24 or to reduce the rate of decline in permeability of membranes 24 over extended periods of time, preferably between 15 days and three months, so as to reduce the frequency of intensive recovery cleanings rather than to provide recovery cleaning itself. In some drinking water applications, however, intensive recovery cleanings can be postponed almost indefinitely. There may be a slight instantaneous increase in permeability of the membranes 24 after a cleaning event, but this permeability gain is typically lost before the next cleaning event and is not significant enough to be considered recovery cleaning.

The weekly CT is preferably in the range of 2,000 min·mg/l to 30,000 min·mg/l when NaOCl is the chemical cleaner. For drinking water applications, the preferred weekly CT is between 5,000 min·mg/l and 10,000 min·mg/l of NaOCl. For waste water applications, the preferred weekly CT is between 10,000 min·mg/l and 30,000 min·mg/l of NaOCl. When other chemical cleaners are used, the concentration of the chemical cleaner should be expressed as an equivalent concentration of NaOCl that has similar cleaning efficacy. For example, for citric acid, preferred values are approximately 20 times those given for NaOCl and for hydrochloric acid, preferred values are approximately 4 times the values given for NaOCl. The precise weekly CT to use in a given application is preferably chosen to achieve a gradual decline in permeability over an extended period of time.

For a given weekly CT, the weekly duration of cleaning events is calculated by dividing the weekly CT by the concentration, C, of chemical cleaner. For NaOCl, a C between 20 mg/l and 200 mg/l is typical. Once the total weekly duration of cleaning events is known, the frequency of cleaning events is next determined. Frequent cleaning events may be more effective and provide less variation in permeability of the membranes 24 over time but require more frequent disruptions to permeation. Preferably, cleaning events are also not so frequent that, given the residence time of the tank 20 or permeate tank 37, residual chemical cleaner from a prior cleaning event is still present at the start of the next cleaning event in significant amounts. Cleaning events are performed preferably between 1 and 7 times per week and more preferably between 2 and 4 times per week. The duration, T, of each cleaning event is then determined by dividing the weekly duration of cleaning events by the number of times per week that cleaning events are performed. T typically ranges from 10 to 100 minutes and more typically from 30 minutes to 60 minutes, 30 minutes for drinking water applications and 60 minutes for wastewater applications.

Once the duration of each cleaning event is known, the flow rate of chemical cleaner during each cleaning event is determined. The flow rate is chosen to maintain an area in and adjacent to the membranes 24 in which the chemical cleaner is substantially undiluted and effective.

Chemical cleaner may be applied at a steady rate over a significant portion of the duration, T, of the cleaning event. The permeate pump 32 or chemical pump 67, whichever governs, is controlled to feed the cleaning chemical into the membranes 24 at a low pressure.

Preferably, however, the chemical cleaner is supplied to the membranes 24 in pulses rather than continuously. In the time between pulses, the chemical cleaner moves from the area in or adjacent the membranes 24 into the tank water 22 generally and reacts with solids, thus losing its efficacy. The concentration and efficacy of chemical cleaner in the area in or adjacent the membranes 24 over the duration T of the cleaning event is still sufficient, however, to provide cleaning in this area.

With a pulsed delivery of chemical cleaner, a higher pressure is used to deliver the same volume of chemical cleaner compared to when the chemical cleaner is delivered under constant pressure over the same T. This assists in reducing the relative size of variations in head losses in the membranes 24 or the piping to the membranes 24. Further, membranes rarely foul evenly and the pulsed delivery of chemical cleaner assists in providing an even distribution of chemical cleaner across the surface of the membranes 24. With less variable flow of chemical cleaner from one part of the membranes 24 to another, less chemical cleaner is required to achieve a minimum level of cleaning throughout the membranes 24. The pulsed chemical cleaner delivery is particularly beneficial for modern submerged outside-in hollow fibre membranes 24 which may be between 1 metre to 3 metres in length, resulting in significant pressure drop in the membranes 24, but having unfouled permeability of a few hundred litres per square meter per hour per bar of transmembrane pressure (L/m²/h/bar) or more. With such membranes, a pulse pressure between 5 and 55 kPa above the pressure on the outside of the membranes 24 is preferred.

Preferably, the pulses last for between 10 seconds and 100 seconds, preferably between 20 seconds and 60 seconds and more preferably 30 seconds for wastewater applications and 60 seconds for drinking water applications. In either application, however, the first pulse is preferably longer, about two minutes, to purge the membranes 24 of tank water 22. Preferably, the permeate pump 32 or chemical pump 67, whichever is controlling, supplies the chemical cleaner to the membranes 24 with sufficient pressure to produce a flux of chemical through the membranes 24 between 8.5 L/m²/h and 51 L/m²/h. Where the cleaning is in situ, a flux near 8.5 L/m²/h is preferred for drinking water applications and a flux near 20 L/m²/h is preferred for wastewater applications. Where the cleaning is done in an empty tank, a higher flux around 40 μm²/h is preferred. After each pulse, the flow of chemical cleaner is stopped for a waiting period preferably between 50 seconds and 6 minutes and more preferably about 3 minutes for drinking water applications and about 5 minutes for wastewater applications. The pulse and waiting period may be repeated and preferably are repeated between 5 and 30 times.

The relationship between the length of the pulse and the waiting period between pulses is preferably such that the chemical cleaner remains substantially effective during the waiting period despite decreasing in efficacy from an initial efficacy and is restored to the initial efficacy by the subsequent pulse. Providing too short a time between pulses increases the amount of chemical required by forcing it into the tank prematurely while providing too long a time between pulses wastes process time because the chemical cleaner is not substantially efficacious for the entire time.

The pulses are controlled by altering the speed of the chemical pump 67 with a speed controller 100 to get the desired flux during the parts of the chemical backwash cycle during which the chemical pump 67 is on. Preferably, the speed controller 100 is in turn controlled by a programmable logic controller 102. The programmable logic controller (PLC) 102 is programmed to turn the chemical pump 67 on and off as required for the cleaning event. A flow sensor 106 in the backwash line 63 measures the chemical flux and converts this information to an analog current (typically 4-20 milli-amp) or potential signal proportional to the flux. The PLC 102 converts this signal to a flux reading, compares the flux reading to a desired flux programmed in its memory and sends a 4-20 mA or 4-20 mV signal to the speed controller 100. The speed controller 100 changes the frequency of the electric current to the chemical pump 67 in proportion to the signal presented by the PLC 102, which changes the speed of the chemical pump 67, and hence, the cleaning chemical flux. If the flux is below the desired value, the speed of the chemical pump 67 is increased by the PLC 102 and conversely decreased if the flux is to high.

The amount of chemical cleaner used per square metre of surface area of the membranes 24 per week is between 50 and 1000 mg of NaOCl, but is preferably between 220 and 550 mg of NaOCl. When other chemical cleaners are used, an amount of chemical cleaner is used which is equivalent to the amount of NaOCl specified above in cleaning efficacy. Such a dosage, spread out over the cleaning events in a week, is low enough that it does not disrupt the population of microorganisms to the point where a spike of pollutants makes the effluent quality unsatisfactory.

For drinking water applications where the cleaning is done in situ, the total volume of chemical cleaner introduced into the tank water 22 in each cleaning event, called the cleaning event dosage, is monitored. The cleaning event dosage preferably does not exceed the most limiting regulatory or design limit on the concentration of chemical cleaner in the permeate at any point of use. For example, with chlorine based chemical cleaners, trihalomethane formation is likely to be the controlling factor and can be predicted using trihalomethane formation tables. In appropriate circumstances, the volume of the permeate tank 37 may be considered in calculating the cleaning event dosage. Similarly, any prechlorination or chemical cleaner remaining in the tank 20 from a preceding cleaning event should be accounted for in determining whether a cleaning event dosage is acceptable. On the other hand, some of the chemical cleaner will react with organics in the tank water 22 resulting in lower residual chemical cleaner.

In many cases, the cleaning event dosage will be well below the maximum cleaning event dosage that could be used. However, if this does not occur in a particular application, the cleaning regime is altered to give acceptable cleaning event dosages. In some cases, altering the frequency of cleaning events may produce acceptable cleaning event dosages without reducing the weekly CT, but in other cases a higher fouling index and lower weekly CT may be required. If these measures still do not produce acceptable levels of residual chemical cleaner, then for drinking water applications some or all of the tank water 22 is drained after the cleaning events and replaced with feed water 14. Alternatively, the continuous process can be replaced with a batch process and the cleaning events performed when the tank is empty.

After a cleaning event as described above, backwash valves 60 are closed, permeate valve 34 is re-opened, pressure tank 64 opened if and as necessary to refill pressure tank 62, and permeation continues. New chemical cleaner is added to the chemical tank 68 as needed.

In another preferred embodiment, the cleaning steps are performed as described above with the exception that the chemical valve 66, chemical pump 67 and chemical tank 68 are replaced with a hot water valve 70, hot water pump 72 and water heater 74, except as described differently below. The water heater 74 delivers heated water, preferably above 25 celsius and more preferably between 40 celsius and the maximum temperature that the membrane can withstand, typically from 50 celsius to 120 celsius in which case the heated water may be steam. The inventors believe that the hot water or steam solubilizes some of the solids, particularly organic matter, both on the surface of the membranes 24 and in the pores of the membranes 24. The solubilized solids travel through the membranes 24 by permeation or disperse into the tank water 22. Solids may or may not be completely removed, but removing part of the solids with each cleaning event slows the long term rate of loss of permeability of the membranes 24.

The hot water may also kill some microorganisms attached to the membranes although it is not necessary to kill the microorganisms to achieve the desired effect. However, water heated above 60 or 70 celsius and steam are known to kill the bacteria and are preferred if a large portion of the solids are bacteria.

Since no chemical cleaner is used, the flux of hot water or steam, the number and duration of the pulses and the wait time between them, and the frequency of cleaning events are not limited by resulting chemical concentrations but rather excess heating the tank water 22. The heated water may be provided continuously over a cleaning event but is preferably provided in pulses. Process parameters are preferably chosen to provide heated water in an area adjacent the membranes 24 for a sufficient amount of time such that at least readily solubilizable solids, particularly exopolymeric substances and other organic compounds and some inorganic compounds, may be solubilized.

Preferably, the pulses last for between 10 seconds and 100 seconds and have sufficient pressure to produce a flux of heated water through the membranes 24 between 8.5 L/m²/h and 51 L/m²/h. After each pulse, the flow of heated water is stopped for a waiting period preferably between 50 seconds and 3 minutes and more preferably between 50 seconds and 1 minute in length. After the waiting period, the pulse and waiting period may be repeated and preferably are repeated so that the cleaning event is between 30 minutes and 90 minutes in duration. Such cleaning events are preferably repeated between twice a day and once every two days and more preferably once a day.

When hot water is used in place of chemical cleaners, the heated water or steam can also be applied to the retentate side 27 of the membranes 24 by injection into the tank 20 or by heating the feed water 14. In the former case, permeation can be stopped momentarily to allow the membrane surfaces to be heated and then restarted to draw the dissolved solids through the membrane.

### EXAMPLE 1

Waste Water Treatment

An experimental membrane bioreactor using a ZEEWEED 500 membrane module having 46 square metres of membrane surface area was built for treating waste water and, in particular, for carbon oxidation, nitrification and phosphorus removal. At all times, the flow rate of permeate through the membranes was maintained at 25.5/m²/h and the solids concentration in the bioreactor averaged between 15 g/l and 20 g/l. The average flow through the bioreactor was 1,000 cubic metres per day and the peak flow was 2,000 cubic metres/day.

The bioreactor was first operated without cleaning according to the invention for 90 days. Permeability was not sustainable and decreased continuously. At the end of this time, permeability of the membranes had dropped to less than 75 L/m²/h/bar.

The bioreactor was then operated with a fresh membrane module for 90 days with maintenance cleaning according to the present invention. The cleaning was performed twice per week using 100-125 mg/l NaOCl solution for one hour in pulses at a rate of 430 mg per square metre per week. The permeability of the membranes decreased slowly and eventually stabilised at about 187.5 L/m²/h/bar.

On an average basis, no significant decrease in effluent quality in terms of ammonia-nitrogen or total phosphorous occurred when cleaning according to the present invention was instituted. Concentration of cBOD5 in the effluent both with and without cleaning according to the present invention averaged 1.0 mg/l.

### EXAMPLE 2

Potable Water

An experimental membrane bioreactor using ZEEWEED 10 membrane modules having 0.9 square metres of membrane surface area each was built for treating lake water to produce potable water. All experiments were performed at constant flux in which the flow is kept constant and the transmembrane pressure (TMP) was allowed to increase as membranes fouled. The raw water conditions were as follows:
1 Temperature (C.) 10-20 TOC (mg/l) 3.0-5.0 Turbidity (ntu) 4.0-9.0 Apparent Colour (Pt Co units) 10-50 True Colour (Pt Co units) 5.0-20.0

Experiments were performed with and without maintenance cleaning and at different fluxes. Cleaning events were done three times per week with 100 mg/l NaOCl for 30 minutes. The cleaning dosage was between 320 and 430 mg NaOCl per square metre of membrane per week.

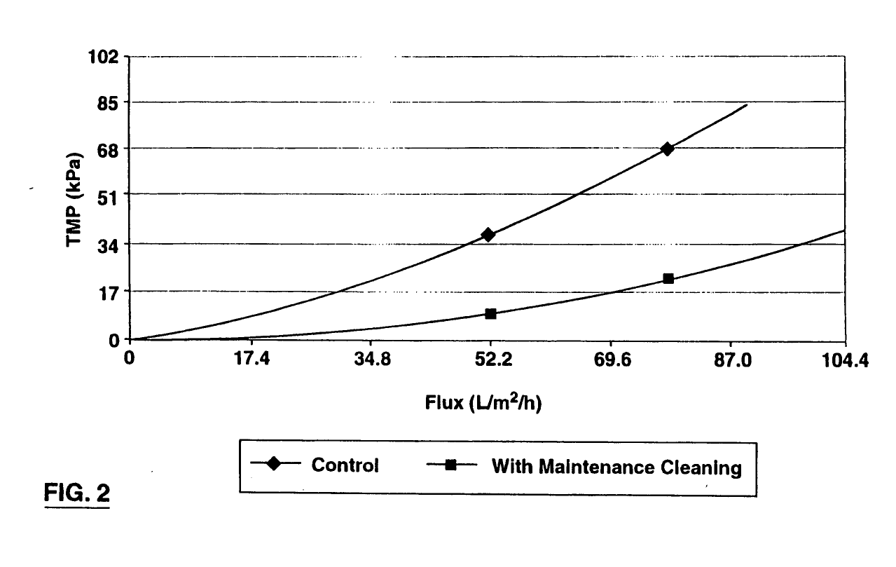

FIG. 2 summarises the results obtained with and without maintenance cleaning. Each test lasted about 45-60 days. After an initial increase in TMP, the TMP reached a relatively constant value which is referred to as the sustainable TMP. Sustainable TMP is plotted as a function of fixed operating flux. Permeability can be calculated by dividing the operating flux by TMP. In this figure, the “control” condition refers to operation without maintenance cleaning. Substantial improvement in sustainable TMP was obtained using maintenance cleaning.

The residual chlorine concentration in the process tank after each cleaning event was less than 0.5 mg/l. This level of residual chlorine in the process tank was low enough to continue the filtration process to produce potable water.

### EXAMPLE 3

Heated Water as a Chemical Cleaner

An experimental membrane bioreactor was built for treating a typical municipal waste water. ZW10 membrane modules were used each having a surface area of 0.9 square metres. The concentration of biomass was between 15 to 20 gMLSS/L, corresponding to a volumetric loading of between 1.2 to 2.3 kg COD/m3/d. COD and TKN removal were better than 95% with dissolved oxygen residuals between 0.5 and 1.5 mg O₂/L in the tank.

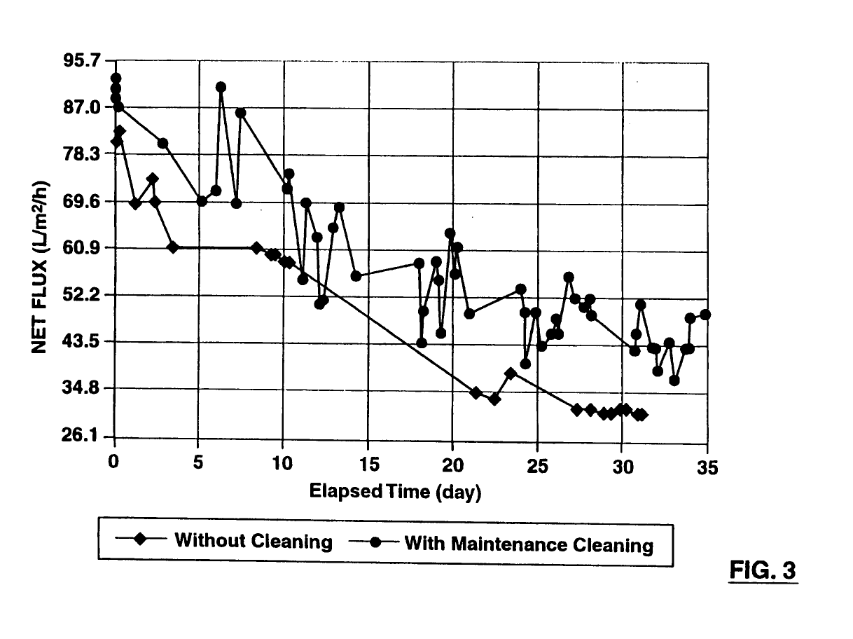

Experiments were performed at a constant transmembrane pressure of 34 kPa and the permeate flux was allowed to decline as the membranes fouled. Two modules were tested under the same conditions, one with and one without heated water maintenance cleaning. For cleaning, heated water maintenance cleaning was performed with water heated to 40C for 1 hour every day. FIG. 3 shows the net flux results as a function of time and indicates that the heated water maintenance cleaning resulted in an improvement in flux averaging between 8.7 and 17.4 L/m²/h over the duration of the test.

It is to be understood that what has been described are preferred embodiments to the invention. The invention nonetheless is susceptible to changes and alternative embodiments without departing from the invention, the scope of which is defined in the following claims.

1. A process for filtering water containing solids with membranes in a tank comprising the steps of:
a) filling the tank with a feed water to be filtered to immerse the membranes;
b) creating a transmembrane pressure between a permeate side and a retentate side of the membranes, the retentate side of the membranes being in contact with the water in the tank at ambient pressure, the permeate side being subject to a negative pressure relative to the pressure of the water in the tank fluidly connected to a filtered permeate outlet, to generate a filtered permeate at the permeate outlet and a retentate in the tank;
c) aerating the membranes to dislodge solids from the membranes;
d) backwashing the membranes; and,
e) draining the tank of the retentate;
wherein
i) the steps above are performed in repeated cycles; and,
ii) the steps of backwashing the membranes and draining the tank in a cycle may be performed either before the other or partially or substantially simultaneously; and,
f) wetting the membranes at least once per week with a cleaning chemical having a selected concentration for a selected duration after performing step (b) in a first cycle and after or while performing step (e) in the first cycle, without returning to step (b) in the first cycle and before starting a subsequent cycle.

2. The process of claim 1 wherein the repeated cycles of part (i) of claim 1 are repeated at least once a day and step (f) is repeated between once a day and once per cycle of part (i) of claim 1.

3. The process of claim 1 further comprising the steps of performing recovery cleanings from time to time to increase the permeability of the membranes wherein the steps of claim 1 are performed between the recovery cleanings and reduce the rate of a decline in permeability of the membranes between the recovery cleanings.

4. The process of claim 1 wherein the sum of the products of the selected concentration and selected duration of part (f) of claim 1 is between 2,000 min·mg/l and 30,000 min·mg/l per week over a period of at least 1 month when NaOCl is the cleaning chemical or an equivalent product of concentration and time of another cleaning chemical.

5. The process of claim 3 wherein the recovery cleanings are performed at least 1 month apart from each other.

6. The method of claim 4 wherein the steps of part (f) of claim 1 are performed at regular intervals and each have about the same product of selected concentration and selected duration.

7. A method for cleaning one or more membranes normally immersed in water containing solids held at ambient pressure in a tank and used to produce a permeate on the insides of the membranes, comprising the steps of:
(a) cleaning the membranes to increase the permeability of the membranes,
(b) after step (a), performing one or more cleaning events per week over a period of at least 15 days, each cleaning event further comprising the steps of flowing a chemical cleaner through the membranes to provide a chemical cleaner in or adjacent the membranes for a period of time; and,
(c) choosing the concentration of the chemical cleaner provided in step (b) and the period of time in step (b) such that the cleaning events reduce the rate of a decline in permeability of the membranes over the period of at least 15 days;
wherein steps (a) to (c) are performed in repeated cycles with step (a) in a cycle beginning after the end of steps (b) and (c) in a preceding cycle.

8. The method of claim 7 wherein the decrease in permeability of the membranes between consecutive cleaning events is typically at least as great as the increase in the permeability of the membranes after each of the consecutive cleaning events such that the permeability of the membranes decreases over the period of at least 15 days.

9. The method of claim 7 wherein the chemical cleaner contains between about 20 ppm and 200 ppm of chlorine.

10. The method of claim 7 wherein the membranes are hollow fibre porous membranes.

11. The method of claim 10 wherein the membranes have an average pore size between 0.003 microns and 10 microns, are oriented generally vertically and each have a length between 1 m and 3 m.

12. The method of claim 7 wherein the cleaning events are started while the permeability of a membrane is still more than 70% of its fresh permeability.

13. The method of claim 7 wherein the amount of chemical cleaner used per square meter of surface area of the membranes per week is between 50 and 1000 mg of NaOCl or equivalent.

14. The method of claim 7 wherein the cleaning events are performed at least twice per week.

15. The method of claim 7 wherein
(a) the period of time is deemed to be the time during which the chemical cleaner is flowed through the membranes plus the shorter of (i) 5 minutes, (ii) the time between when the chemical cleaner stops flowing through the membranes and when the membranes are agitated, (iii) the time between when the chemical cleaner stops flowing through the membranes and permeate is withdrawn through the membranes, and (iv) the time between when the chemical cleaner stops flowing through the membranes and the membranes are backwashed with permeate; and,
(b) each cleaning event has a CT which is equal to (A) the concentration of the chemical cleaner expressed as an equivalent concentration of NaOCl in cleaning efficiency multiplied by (B) the period of time; and,
(c) the one or more cleaning events has a weekly CT's which is equal to the sum of the CT's of the one or more cleaning events performed in a week and is between 2000 minutes·mg/L and 20,000 minutes·mg/L.

16. The method of claim 7 wherein
(a) the period of time is deemed to be the time during which the chemical cleaner is flowed through the membranes plus the shorter of (i) 5 minutes, (ii) the time between when the chemical cleaner stops flowing through the membranes and when the membranes are agitated, (iii) the time between when the chemical cleaner stops flowing through the membranes and permeate is withdrawn through the membranes, and (iv) the time between when the chemical cleaner stops flowing through the membranes and the membranes are backwashed with permeate; and,
(b) each cleaning event has a CT which is equal to (A) the concentration of the chemical cleaner expressed as an equivalent concentration of NaOCl in cleaning efficiency multiplied by (B) the period of time; and,
(c) the one or more cleaning events has a weekly CTs which is equal to the sum of the CT's of the one or more cleaning events performed in a week and is between 10,000 minutes-mg/L and 30,000 minutes·mg/L and the membranes are normally immersed in wastewater.

17. The method of claim 7 wherein the cleaning events are performed at regular intervals and each have the same CT, wherein the CT of each cleaning event equal to (A) the concentration of the chemical cleaner expressed as an equivalent concentration of NaOCl in cleaning efficiency multiplied by (B) the period of time.

18. The method of claim 7 wherein step (b) further comprises flowing a chemical cleaner to the one or more headers in a series of pulses, wherein the pulses are separated from each other by waiting periods in which the flow of chemical cleaner is stopped wherein all chemical cleaner reaching the one or more headers remains in the enclosed space of the one or more modules or flows through the walls of the membranes in a direction opposite to the direction in which permeate normally passes through the walls of the membranes.

19. The method of claim 18 wherein the pulse steps last for between 10 seconds and 100 seconds and the waiting periods last for between 50 seconds and 6 minutes.

20. The method of claim 18 wherein the pulse steps last for at least 10 seconds and the waiting periods last for at least 50 seconds.

21. The method of claim 18 wherein the length of the pulse steps is selected to provide chemical cleaner in an area in the membranes and in an area in tank water adjacent the outside of the membranes with an initial efficacy and the length of the waiting periods is selected to provide substantially effective chemical cleaner in an area in the membranes and an area in tank water adjacent the outsides of the membranes during the waiting eriod.

22. The method of claim 18 wherein the membranes are hollow fibre membranes and the pressure of the cleaning chemical in the pulse steps is between 5 kPa and 55 kPa above the pressure on the outside of the membranes.

23. The method of claim 18 wherein the flow through the membranes during the pulse steps is between 8.5 and 51 L/m²/h.
